(19) United States
(12) Patent Application Publication
(10) Pub. No.: US 2012/0274569 A1
(43) Pub. Date: Nov. 1, 2012

(54) ELECTRONIC DEVICE WITH ENHANCED FEATURES

(76) Inventor: Vladimir Vitalievich Miroshnichenko, Ljubertsi (RU)

(21) Appl. No.: 13/261,096

(22) PCT Filed: Dec. 27, 2010
(86) PCT No.: PCT/RU2010/000789

§ 371 Date: Dec. 21, 2011

(30) Foreign Application Priority Data
Dec. 30, 2009 (RU) 2009149048

(51) Int. Cl. G06F 3/02

(52) U.S. Cl. 345/168

(57) ABSTRACT

The invention is aimed at improvement of control variability of an electronic device. An electronic device, comprising a data output display or a data output and input display (O/I display), movable in one or two or more than two sides relative to the electronic device body, wherein when the electronic device takes at least one of spatial positions or when the user releases from the hand the electronic device or when the O/I display is moved or has been moved relative to the electronic device body or when the O/I display is fixed at least in one of spatial positions relative to the electronic device body on the O/I display and/or on the additional display and/or on touch screen display or display of a non-sensor type or partially touch screen display placed under the O/I display are changed layout of image into vertical layout of image and vice versa.

### CROSS-REFERENCE TO RELATED APPLICATIONS

This application is a U.S. national stage application of a PCT application PCT/RU2010/000789 filed on 27 Dec. 2010, published as WO/2011/081570, whose disclosure is incorporated herein in its entirety by reference, which PCT application claims priority of a Russian Federation application RU2009149048 filed on 30 Dec. 2009.

### FIELD OF THE INVENTION

The invention relates to electronic devices and provides the user of an electronic device with additional functional options.

### BACKGROUND OF THE INVENTION

Modern electronic devices, among which are mobile phones, smart phones, communicators, portable radio sets, PDA, game consoles, digital cameras, digital camcorders, netbooks, electronic books, computer tablets or other devices with a data output display or a data output and input display, are incorporated in the bodies with various methods of their transformation. The most common models are sliders and folders. The sliders and folders are also divided by transformation methods. For example, among [symbol] sliders [symbol] there is an upper slider, where the upper part of the body relative to the body itself moves along the long side of an electronic device body, and a sidelong slider, where the upper part of the body relative to the body itself moves along the short side of this electronic device.

There are some slider models, wherein the upper part moves in various directions relative to the lower part, e.g., such model is described in the patent application US 20060046796 A1.

Among the bodies of a [symbol] folder [symbol] type are the upper and the sidelong models, herewith the upper part is attached to the lower part by means of a hinge connection.

Among the drawbacks of the aforesaid embodiments are:
When a user of an electronic device performs some manipulations, e.g. enters a text message, it is necessary to move display to the lateral side or in another direction significantly;
Current keyboard layouts do not provide a user with comfortable control of his/her electronic device to the full extent;
A user has to perform manipulations, which can be done by the device automatically;
Display movement relative to the body of an electronic device is not related to the actions, required for the user of this electronic device;
Display movement relative to the body of an electronic device is not related to a change of functional options of the said device.

The nearest equivalent (prior art) of the first, second, fifth and sixth embodiments of the invention described herein is the US 2010/0129782 A1, wherein an electronic book with opposed displays facing each other on a foldable housing can present book text on each page in portrait mode. Upon receipt of a mode change signal caused by, for example, the user rotating the book 90°, the lower display can display an image of a keyboard and/or text in landscape mode while the upper display can present text in landscape mode. The keyboard image may be for a user-selected language.

Referring to the first and fifth embodiments of the invention described herein the drawback of the said technical solution is that it applies only to electronic books or portable computer sets and doesn't provide the use of said technical solution in portable communication devices, digital cameras and digital camcorders.

Referring to the second and sixth embodiments of the invention described herein the drawback of the said technical solution is that the layout of virtual symbols displayed in an electronic book are changed only upon the user rotating the said book 90° and it doesn't provide changing the layout of virtual symbols displayed when the user releases from the hand or hands the electronic device or when the display is moved or has been moved relative to the electronic device body or when the display is fixed at least in one of spatial positions relative to the electronic device body.

Referring to the third and fourth embodiment of the invention described herein it's failed to find any prior arts in available information sources.

Referring to the seventh embodiment of the invention the nearest equivalent (prior art) of the seventh embodiment of the invention described herein is the US20110034213 A1. Major drawback of the prior art is that the upward keyboard layout, as described, is not always efficient when the display screen is located in the lateral side position. Also the relationship between the display movement and the actions, which can be performed, as a result, without any manipulations made by the user, is not implemented.

### OBJECTIVES AND DESCRIPTION OF THE INVENTION

The invention described herein is aimed at improvement of control variability of an electronic device equipped with a data output display or a data output and input display, as well as meeting the user's ergonomic needs when operating with the above-mentioned device. The use of the invention described herein provides the user of an electronic device equipped with a data output display or a data output and input display with additional functional options.

For proper understanding and interpretation of the terminology relating the group of the inventions described herein the following terms are used:

Electronic device is one of the electronic devices among which are mobile phones, smart phones, communicators, portable radio sets, PDA, game consoles, digital cameras, digital camcorders, netbooks, electronic books, computer tablets or other devices comprising a data output display or a data output and input display.

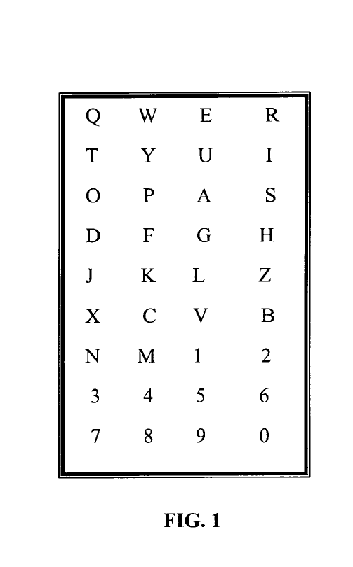

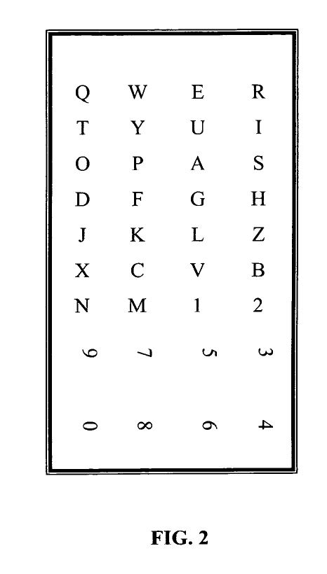

Lengthwise layout of a keyboard displayed on a display screen is such a layout, wherein all or most of the symbols displayed on a display screen are directed towards the short side of their location on the screen, herewith the short side of a display screen is generally an upper or a lower part of the display screen. The symbols sectors are located on the display screen in such a manner that occupy larger surface along the display screen than that across the display screen. Lengthwise layout of an alphanumeric keyboard displayed on a display screen is the same. Lengthwise keyboards displayed on a display screen are shown in FIG. 1 and FIG. 2.

Horizontal layout of a keyboard displayed on a display screen is such a layout, wherein all or most of the symbols displayed on a display screen are directed towards the long side of their location on the screen. Horizontal layout of an alphanumeric keyboard displayed on a display screen is the same.

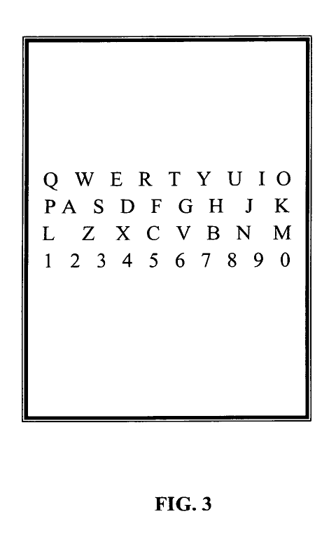

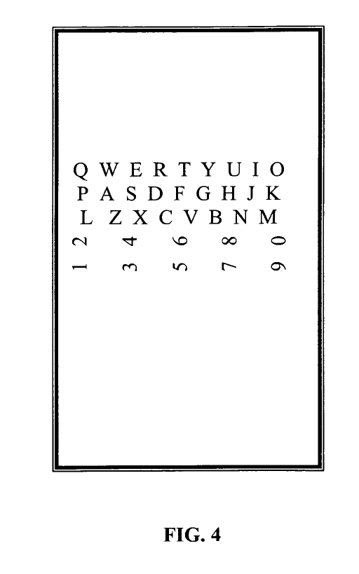

Upward layout of a keyboard displayed on a display screen is such a layout, wherein all or most of the symbols displayed on a display screen are directed towards the short side of their location on the screen, herewith the short side is generally an upper or a lower part of the display screen. The sectors of the symbols are located on the screen in such a manner that occupy less or equal surface along the display than that across the display. An alphanumeric keyboard of symbols displayed on a display screen has the same upward layout. Upward layouts of a keyboard displayed on a display screen are shown in FIG. 3 and FIG. 4.

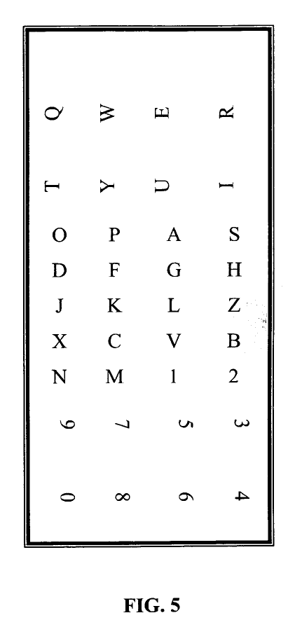

Multidirectional layout of a keyboard displayed on a display screen is such a layout, wherein at least two symbols (e.g. alphabetic symbol and/or a numeric symbol) have various directions. Alphanumeric keyboard displayed on a display screen has the same multi-directional layout. Keyboard with multi-directional layout is shown in FIG. 5.

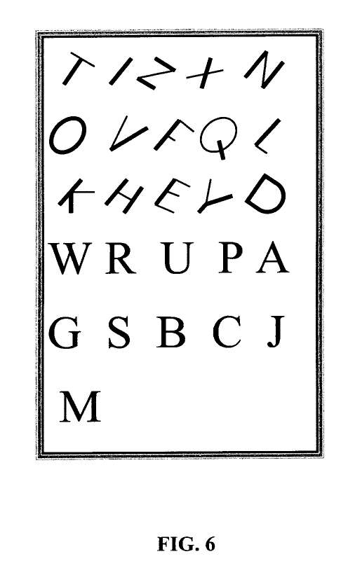

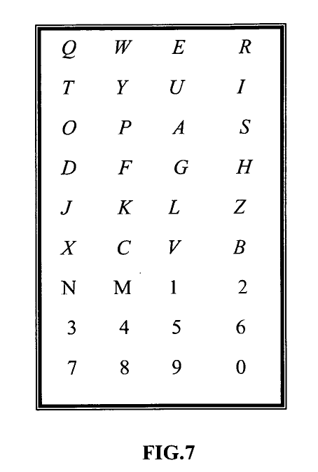

Diagonal layout of a keyboard displayed on a display screen is such a layout, wherein all symbols or most of the symbols displayed on the screen are oriented between direction to the short side of the display surface and direction towards the long side of the display surface. An alphanumeric keyboard displayed on a display screen has the same diagonal layout. Diagonal layout of a keyboards displayed on a display screen are shown in FIG. 6, FIG. 7.

Data input display of an electronic device is a display on the surface of which a user through manipulations performs some actions supported by the device's software.

Data output-input display is a display on the surface of which a user through manipulations enters some characters (alphabetical, numerical characters, etc.) and performs actions supported by the device's software as well as through which (i.e. display) an information is output.

Back-and-rigid connection of a movable display with the electronic device body is such connection, when the display can move either backwards or at least in one more direction relative to the body of an electronic device by means of user's manipulations; upon completion of user's manipulations the display automatically returns to its initial position, e.g., by means of a spring or spring mechanism. Back-and-rigid connection designs are not described herein.

Keyboard with full layout is a keyboard, wherein one alphabetic or one numeric character at least of one device's alphabet is assigned to one button (in case of a button keyboard), or a keyboard, wherein one alphabetic or one numeric character is assigned to an on-screen sector (e.g., a sector may be displayed as a button) (in case of a keyboard displayed on a display screen). Example of such full layout is QWERTY keyboard.

Keyboard with short layout is a keyboard, wherein more than one alphabetic character at least of one device's alphabet are assigned to one button (in case of a button keyboard), or a keyboard, wherein more than one alphabetic character are assigned to an on-screen sector (e.g., a sector may be displayed as a button) (in case of a keyboard displayed on a display screen).

[symbol] Slider [symbol] is a type of an electronic device's body, consisting of at least two parts, not fixed on one common axis, but located in two parallel planes and connected with each other via a special mechanism, allowing these parts to move along each other in the said planes, either in one or different directions.

[symbol] Side slider [symbol] is a slider model, where the display moves along the short side of an electronic device in one direction relative to the device's body. After the display was moved thereby along the short side of the device it can also move in some other directions, as provided by the design of this electronic device. Implementation of this option is not described herein.

[symbol] Double side slider [symbol] is a slider model, where the display moves along the short side of an electronic device in two directions relative to the device's body. After the display was moved thereby along the short side of the device it can also move in some other directions, as provided by the design of this electronic device. Implementation of this option is not described herein.

[symbol] Multi-side slider [symbol] is a slider model, where the display moves in various directions along the device.

[symbol] Side folder [symbol] is a type of an electronic device's body, consisting of minimum two parts, connected with each other by means of a hinge, located on the long side of the device.

Rear side of an electronic device is a side, which is opposite to the front panel of the device.

Referring to the first embodiment of the invention the above mentioned technical result is achieved as follows:

An electronic device, comprising a data output display, movable relative to the electronic device body, or a data output and input display, movable relative to the electronic device body (hereinafter “a data output display or a data output and input display” referred to as “O/I display”), wherein at least on one surface of an electronic device is located entirely or partially at least one additional data input and output display (hereinafter referred to as [symbol] additional display [symbol] ), herewith when the electronic device takes at least one of spatial positions:

on the O/I display, or

on the additional display, or

on the O/I display and on the additional display

are changed the following: (a) the size or configuration or color or position at least of one displayed virtual symbol or virtual object or virtual icon, or (b) mutual position of the displayed virtual symbols or objects or icons, or (c) displayed virtual symbols or objects or icons into another symbols or objects or icons, or (d) the number of the displayed virtual symbols or objects or icons, or (e) horizontal layout of image into vertical layout of image and vice versa, or f) layout of the alphanumeric keyboard virtually displayed from short layout into the full layout and vice versa, or g) at least one alphabet of the alphanumeric keyboard virtually displayed, or h) a number of alphabets of the alphanumeric keyboard virtually displayed, or i) at least one layout of the keyboard virtually displayed into a lengthwise or a multi-directional or a horizontal or an upward or a diagonal layout, or j) layout of at least one alphabet on the alphanumeric keyboard virtually displayed into a lengthwise or a multi-directional or a horizontal or an upward layout or into the O/I display image layout or vice versa, or (k) any combination of mentioned in the sub-clauses (a)-(j);

herewith said electronic device is a mobile phone or a smart phone or a communicator or portable radio set or a game console or a digital camera or a digital camcorder.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

There may be at least one spatial position of the O/I display relative to the electronic device body, when the connection of the O/I display with the electronic device body is understood as a back-and-rigid connection.

The body of an electronic device may be a side slider or a double side slider or a multi-side slider or a side folder.

Referring to the second embodiment of the invention the above mentioned technical result is achieved as follows:

An electronic device, comprising a data output display, movable relative to the electronic device body, or a data output and input display, movable relative to the electronic device body (hereinafter “a data output display or a data output and input display” referred to as “O/I display”), wherein at least on one surface of an electronic device is located entirely or partially at least one additional data input and output display (hereinafter referred to as [symbol] additional display [symbol] ), herewith: when the user releases from the hand or hands the electronic device or when the O/I display is moved or has been moved relative to the electronic device body or when the O/I display is fixed at least in one of spatial positions relative to the electronic device body:

on the O/I display, or

on the additional display, or

on the O/I display and on the additional display

are changed the following: (a) the size or configuration or color or position at least of one displayed virtual symbol or virtual object or virtual icon, or (b) mutual position of the displayed virtual symbols or objects or icons, or (c) displayed virtual symbols or objects or icons into another symbols or objects or icons, or (d) the number of the displayed virtual symbols or objects or icons, or (e) horizontal layout of image into vertical layout of image and vice versa, or f) layout of the alphanumeric keyboard virtually displayed from short layout into the full layout and vice versa, or g) at least one alphabet of the alphanumeric keyboard virtually displayed, or h) a number of alphabets of the alphanumeric keyboard virtually displayed, or i) at least one layout of the keyboard virtually displayed into a lengthwise or a multi-directional or a horizontal or an upward or a diagonal layout, or j) layout of at least one alphabet on the alphanumeric keyboard virtually displayed into a lengthwise or a multi-directional or a horizontal or an upward layout or into the On display image layout or vice versa, or (k) any combination of mentioned in the sub-clauses (a)-(j);

herewith said electronic device is a mobile phone or a smart phone or a communicator or portable radio set or PDA or a game console or a digital camera or a digital camcorder or a netbook or an electronic book or a computer tablet or any other device with a On display, movable relative to the electronic device body.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

There may be at least one spatial position of the O/I display relative to the electronic device body, when the connection of the O/I display with the electronic device body is understood as a back-and-rigid connection.

The body of an electronic device may be a side slider or a double side slider or a multi-side slider or a side folder.

Referring to the third embodiment of the invention the above mentioned technical result is achieved as follows:

An electronic device, comprising a data output display, movable in one side or in two lateral sides or more than in two sides relative to the electronic device body, or a data output and input display, movable in one side or in two lateral sides or more than in two sides relative to the electronic device body (hereinafter “a data output display or a data output and input display” referred to as “O/I display”), wherein under the O/I display is placed partially or entirely a partially touch screen display; herewith said electronic device is a mobile phone or a smart phone or a communicator or portable radio set or PDA or a game console or a digital camera or a digital camcorder or a netbook or an electronic book or a computer tablet or any other device with a O/I display, movable in one side or in two lateral sides or more than in two sides relative to the electronic device body.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

There may be at least one spatial position of the On display relative to the electronic device body, when the connection of the O/I display with the electronic device body is understood as a back-and-rigid connection.

The body of an electronic device may be a side slider or a double side slider or a multi-side slider or a side folder.

Referring to the fourth embodiment of the invention the above mentioned technical result is achieved as follows:

An electronic device, comprising a data output display, movable in one side or in two lateral sides or more than in two sides relative to the electronic device body, or a data output and input display, movable in one side or in two lateral sides or more than in two sides relative to the electronic device body (hereinafter “a data output display or a data output and input display” referred to as “O/I display”), wherein under the O/I display is placed partially or entirely a touch screen display or a display of a non-sensor type or a partially touch screen display;
the O/I display is configured to be disconnected from the electronic device body;
being disconnected from the electronic device body, the O/I display interacts with said electronic device through a wired or a wireless connection or the O/I display stops interacting with the electronic device and operates independently;
herewith said electronic device is a mobile phone or a smart phone or a communicator or portable radio set or PDA or a game console or a digital camera or a digital camcorder or a netbook or an electronic book or a computer tablet or any other device with a O/I display, movable in one side or in two lateral sides or more than in two sides relative to the electronic device body.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

The body of an electronic device may be a side slider or a double side slider or a multi-side slider or a side folder.

Referring to the fifth embodiment of the invention the above mentioned technical result is achieved as follows:

An electronic device, comprising a data output display, movable in one side relative to the electronic device body, or a data output and input display, movable in one side relative to the electronic device body (hereinafter “a data output display or a data output and input display” referred to as “O/I display”), wherein under the O/I display is placed partially or entirely a touch screen display or a display of a non-sensor type or a partially touch screen display;
there is at least one position of the O/I display relative to the electronic device body, when the entire surface of a touch screen display or a display of a non-sensor type or a partially touch screen display is available for user manipulations;
herewith when the electronic device takes at least one of spatial positions:

on the O/I display, or

on the O/I display and on said touch screen display or display of a non-sensor type or partially touch screen display

are changed the following: (a) the size or configuration or color or position at least of one displayed virtual symbol or virtual object or virtual icon, or (b) mutual position of the displayed virtual symbols or objects or icons, or (c) displayed virtual symbols or objects or icons into another symbols or objects or icons, or (d) the number of the displayed virtual symbols or objects or icons, or (e) horizontal layout of image into vertical layout of image and vice versa, or 0 layout of the alphanumeric keyboard virtually displayed from short layout into the full layout and vice versa, or g) at least one alphabet of the alphanumeric keyboard virtually displayed, or h) a number of alphabets of the alphanumeric keyboard virtually displayed, or i) at least one layout of the keyboard virtually displayed into a lengthwise or a multi-directional or a horizontal or an upward or a diagonal layout, or j) layout of at least one alphabet on the alphanumeric keyboard virtually displayed into a lengthwise or a multi-directional or a horizontal or an upward layout or into the O/I display image layout or vice versa, or (k) any combination of mentioned in the sub-clauses (a)-(j);

herewith said electronic device is a mobile phone or a smart phone or a communicator or portable radio set or a game console or a digital camera or a digital camcorder.

The electronic device may be configured to disconnect the O/I display from the electronic device body; herewith being disconnected from the electronic device body, the O/I display interacts with said electronic device through a wired or a wireless connection or the O/I display stops interacting with the electronic device and it operates independently.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

There may be at least one spatial position of the O/I display relative to the electronic device body, when the connection of the O/I display with the electronic device body is understood as a back-and-rigid connection.

The body of an electronic device may be a side slider or a double side slider or a multi-side slider or a side folder.

Referring to the sixth embodiment of the invention the above mentioned technical result is achieved as follows:

An electronic device, comprising a data output display, movable in one side relative to the electronic device body, or a data output and input display, movable in one side relative to the electronic device body (hereinafter “a data output display or a data output and input display” referred to as “O/I display”), wherein under the O/I display is placed partially or entirely a touch screen display or a display of a non-sensor type or a partially touch screen display;
there is at least one position of the O/I display relative to the electronic device body, when the entire surface of a touch screen display or a display of a non-sensor type or a partially touch screen display is available for user manipulations;
herewith: when the user releases from the hand or hands the electronic device or when the O/I display is moved or has been moved relative to the electronic device body or when the O/I display is fixed at least in one of spatial positions relative to the electronic device body:

on the O/I display, or

on the O/I display and on said touch screen display or display of a non-sensor type or partially touch screen display

are changed the following: (a) the size or configuration or color or position at least of one displayed virtual symbol or virtual object or virtual icon, or (b) mutual position of the displayed virtual symbols or objects or icons, or (c) displayed virtual symbols or objects or icons into another symbols or objects or icons, or (d) the number of the displayed virtual symbols or objects or icons, or (e) horizontal layout of image into vertical layout of image and vice versa, or f) layout of the alphanumeric keyboard virtually displayed from short layout into the full layout and vice versa, or g) at least one alphabet of the alphanumeric keyboard virtually displayed, or h) a number of alphabets of the alphanumeric keyboard virtually displayed, or i) at least one layout of the keyboard virtually displayed into a lengthwise or a multi-directional or a horizontal or an upward or a diagonal layout, or j) layout of at least one alphabet on the alphanumeric keyboard virtually displayed into a lengthwise or a multi-directional or a horizontal or an upward layout or into the O/I display image layout or vice versa, or (k) any combination of mentioned in the sub-clauses (a)-(j);

herewith said electronic device is a mobile phone or a smart phone or a communicator or portable radio set or PDA or a game console or a digital camera or a digital camcorder or a netbook or an electronic book or a computer tablet or any other device with a O/I display, movable in one side relative to the electronic device body.

The electronic device may be configured to disconnect the O/I display from the electronic device body; herewith being disconnected from the electronic device body, the O/O display interacts with said electronic device through a wired or a wireless connection or the O/I display stops interacting with the electronic device and it operates independently.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

There may be at least one spatial position of the O/I display relative to the electronic device body, when the connection of the O/I display with the electronic device body is understood as a back-and-rigid connection.

The body of an electronic device may be a side slider or a double side slider or a multi-side slider or a side folder.

Referring to the seventh embodiment of the invention the above mentioned technical result is achieved as follows:

An electronic device, comprising a data output display, movable in two lateral sides or more than in two sides relative to the electronic device body, or a data output and input display, movable in two lateral sides or more than in two sides relative to the electronic device body (hereinafter “a data output display or a data output and input display” referred to as “O/I display”), wherein under the O/I display is placed partially or entirely a touch screen display or a display of a non-sensor type or a partially touch screen display;
there is at least one position of the O/I display relative to the electronic device body, when the entire surface of a touch screen display or a display of a non-sensor type or a partially touch screen display is available for user manipulations;
herewith: when the electronic device takes at least one of spatial positions or
when the user releases from the hand or hands the electronic device or
when the O/I display is moved or has been moved relative to the electronic device body or when the O/I display is fixed at least in one of spatial positions relative to the electronic device body:

on the O/I display, or

on said touch screen display or display of a non-sensor type or partially touch screen display, or

on the O/I display and on said touch screen display or display of a non-sensor type or partially touch screen display,

are changed the following: (a) the size or configuration or color or position at least of one displayed virtual symbol or virtual object or virtual icon, or (b) mutual position of the displayed virtual symbols or objects or icons, or (c) displayed virtual symbols or objects or icons into another symbols or objects or icons, or (d) the number of the displayed virtual symbols or objects or icons, or (e) horizontal layout of image into vertical layout of image and vice versa, or f) layout of the alphanumeric keyboard virtually displayed from short layout into the full layout and vice versa, or g) at least one alphabet of the alphanumeric keyboard virtually displayed, or h) a number of alphabets of the alphanumeric keyboard virtually displayed, or i) at least one layout of the keyboard virtually displayed into a lengthwise or a multi-directional or a horizontal or an upward or a diagonal layout, or j) layout of at least one alphabet on the alphanumeric keyboard virtually displayed into a lengthwise or a multi-directional or a horizontal or an upward layout or into the O/I display image layout or vice versa, or (k) any combination of mentioned in the sub-clauses (a)-(j);

herewith said electronic device is a mobile phone or a smart phone or a communicator or portable radio set or PDA or a game console or a digital camera or a digital camcorder or a netbook or an electronic book or a computer tablet or any other device with a O/I display, movable in two lateral sides or more than in two sides relative to the electronic device body.

The electronic device may be configured to disconnect the O/I display from the electronic device body; herewith being disconnected from the electronic device body, the O/I display interacts with said electronic device through a wired or a wireless connection or the O/I display stops interacting with the electronic device and it operates independently.

The width of at least one part of the rear side of an electronic device and/or the average width of the rear side of an electronic device may not exceed 3 (three) centimeters or 4 (four) centimeters or 5 (five) centimeters or 6 (six) centimeters or 7 (seven) centimeters or 8 (eight) centimeters or 9 (nine) centimeters or 10 (ten) centimeters or 11 (eleven) centimeters or 12 (twelve) centimeters or 13 (thirteen) centimeters.

There may be at least one spatial position of the O/I display relative to the electronic device body, when the connection of the O/I display with the electronic device body is understood as a back-and-rigid connection.

The body of an electronic device may be a side slider or a double side slider or a multi-side slider or a side folder.

### DESCRIPTION OF DRAWINGS

Keyboards displayed on a display screen with lengthwise layout of symbols are shown in FIG. 1 and FIG. 2.

Keyboards displayed on a display screen with upward layout of symbols are shown in FIG. 3 and FIG. 4.

A keyboard displayed on a display screen with multi-directional layout of symbols is shown in FIG. 5.

Keyboards displayed on a display screen with diagonal layout of symbols are shown in FIG. 6 and FIG. 7.

### EMBODIMENT OF THE INVENTION

The invention described herein is deemed reasonably practical since technical means and software known from the background art allow developing electronic devices equipped with a data output display or a data output and input display, described in the claimed invention.

### APPLICATIONS OF THE INVENTION

Various embodiments of electronic device equipped with a data output display or a data output and input display, described in the claimed invention herein, may be widely applicable among the users of electronic devices, as they provide the users with additional functional options.

1. An electronic device, comprising
a data output display, movable relative to the electronic device body,
or
a data output and input display, movable relative to the electronic device body (hereinafter “a data output display or a data output and input display” referred to as “O/I display”),
wherein:
at least on one surface of an electronic device is located entirely or partially at least one additional data input and output display (hereinafter referred to as <<additional display>>), herewith when the electronic device takes at least one of spatial positions:
on the O/I display,
or
on the additional display,
or
on the O/I display and on the additional display are changed the following:
(a) the size or configuration or color or position at least of one displayed virtual symbol or virtual object or virtual icon,
or
(b) mutual position of the displayed virtual symbols or objects or icons,
or
(c) displayed virtual symbols or objects or icons into another symbols or objects or icons,
or
(d) the number of the displayed virtual symbols or objects or icons,
or
(e) horizontal layout of image into vertical layout of image and vice versa,
or
f) layout of the alphanumeric keyboard virtually displayed from short layout into the full layout and vice versa
or
g) at least one alphabet of the alphanumeric keyboard virtually displayed,
or
h) a number of alphabets of the alphanumeric keyboard virtually displayed,
or
i) at least one layout of the keyboard virtually displayed into a lengthwise or a multi-directional or a horizontal or an upward or a diagonal layout,
or
j) layout of at least one alphabet on the alphanumeric keyboard virtually displayed into a lengthwise or a multi-directional or a horizontal or an upward layout or into the On display image layout or vice versa,
or
(k) any combination of mentioned in the sub-clauses (a)-(j);
herewith said electronic device is a mobile phone or a smart phone or a communicator or portable radio set or a game console or a digital camera or a digital camcorder.

2. The electronic device according to claim 1, wherein there is at least one spatial position of the O/I display relative to the electronic device body, when the connection of the O/I display with the electronic device body is understood as a back-and-rigid connection.

3. The electronic device according to claim 1, wherein the body of an electronic device is a side slider or a double side slider or a multi-side slider or a side folder.

4. An electronic device, comprising:
a data output display, movable relative to the electronic device body
or
a data output and input display, movable relative to the electronic device body (hereinafter “a data output display or a data output and input display” referred to as “O/I display”),
wherein:
at least on one surface of an electronic device is located entirely or partially at least one additional data input and output display (hereinafter referred to as <<additional display>>), herewith:
when the user releases from the hand or hands the electronic device
or
when the O/I display is moved or has been moved relative to the electronic device body
or
when the O/I display is fixed at least in one of spatial positions relative to the electronic device body:
on the O/I display,
or
on the additional display,
or
on the O/I display and on the additional display are changed the following:
(a) the size or configuration or color or position at least of one displayed virtual symbol or virtual object or virtual icon,
or
(b) mutual position of the displayed virtual symbols or objects or icons,
or
(c) displayed virtual symbols or objects or icons into another symbols or objects or icons,
or
(d) the number of the displayed virtual symbols or objects or icons,
or
(e) horizontal layout of image into vertical layout of image and vice versa,
or
f) layout of the alphanumeric keyboard virtually displayed from short layout into the full layout and vice versa,
or
g) at least one alphabet of the alphanumeric keyboard virtually displayed,
or
h) a number of alphabets of the alphanumeric keyboard virtually displayed,
or
i) at least one layout of the keyboard virtually displayed into a lengthwise or a multi-directional or a horizontal or an upward or a diagonal layout,
or
j) layout of at least one alphabet on the alphanumeric keyboard virtually displayed into a lengthwise or a multi-directional or a horizontal or an upward layout or into the O/I display image layout or vice versa,
or
(k) any combination of mentioned in the sub-clauses (a)-(j);
herewith said electronic device is a mobile phone or a smart phone or a communicator or portable radio set or PDA or a game console or a digital camera or a digital camcorder or a netbook or an electronic book or a computer tablet or any other device with a O/I display, movable relative to the electronic device body.

5. The electronic device according to claim 4, wherein there is at least one spatial position of the O/I display relative to the electronic device body, when the connection of the O/I display with the electronic device body is understood as a back-and-rigid connection.

6. The electronic device according to claim 4, wherein the body of an electronic device is a side slider or a double side slider or a multi-side slider or a side folder.

7. An electronic device, comprising:
a data output display, movable in one side or in two lateral sides or more than in two sides relative to the electronic device body,
or
a data output and input display, movable in one side or in two lateral sides or more than in two sides relative to the electronic device body (hereinafter “a data output display or a data output and input display” referred to as “O/I display”),
wherein under the Oil display is placed partially or entirely a partially touch screen display;
herewith said electronic device is a mobile phone or a smart phone or a communicator or portable radio set or PDA or a game console or a digital camera or a digital camcorder or a netbook or an electronic book or a computer tablet or any other device with a Oil display movable in one side or in two lateral sides or more than in two sides relative to the electronic device body.

8. The electronic device according to claim 7, wherein there is at least one spatial position of the O/I display relative to the electronic device body, when the connection of the O/I display with the electronic device body is understood as a back-and-rigid connection.

9. The electronic device according to claim 7, wherein the body of an electronic device is a side slider or a double side slider or a multi-side slider or a side folder.

10. An electronic device, comprising:
a data output display, movable in one side or in two lateral sides or more than in two sides relative to the electronic device body,
or
a data output and input display, movable in one side or in two lateral sides or more than in two sides relative to the electronic device body(hereinafter “a data output display or a data output and input display” referred to as “O/I display”),
wherein:
under the O/I display is placed partially or entirely a touch screen display or a display of a non-sensor type or a partially touch screen display;
the O/I display is configured to be disconnected from the electronic device body;
being disconnected from the electronic device body, the O/I display interacts with said electronic device through a wired or a wireless connection
or
the O/I display stops interacting with the electronic device and operates independently;
herewith said electronic device is a mobile phone or a smart phone or a communicator or portable radio set or PDA or a game console or a digital camera or a digital camcorder or a netbook or an electronic book or a computer tablet or any other device with a O/I display, movable in one side or in two lateral sides or more than in two sides relative to the electronic device body.

11. The electronic device according to claim 10, wherein the body of an electronic device is a side slider or a double side slider or a multi-side slider or a side folder.

12. An electronic device, comprising
a data output display, movable in one side relative to the electronic device body,
or
a data output and input display, movable in one side relative to the electronic device body (hereinafter “a data output display or a data output and input display” referred to as “O/I display”), wherein:
under the O/I display is placed partially or entirely a touch screen display or a display of a non-sensor type or a partially touch screen display;
there is at least one position of the O/I display relative to the electronic device body, when the entire surface of a touch screen display or a display of a non-sensor type or a partially touch screen display is available for user manipulations;
herewith:
when the electronic device takes at least one of spatial positions:
on the O/I display,
or
on the O/I display and on said touch screen display or display of a non-sensor type or partially touch screen display are changed the following:
(a) the size or configuration or color or position at least of one displayed virtual symbol or virtual object or virtual icon,
or
(b) mutual position of the displayed virtual symbols or objects or icons,
or
(c) displayed virtual symbols or objects or icons into another symbols or objects or icons,
or
(d) the number of the displayed virtual symbols or objects or icons,
or
(e) horizontal layout of image into vertical layout of image and vice versa,
or
f) layout of the alphanumeric keyboard virtually displayed from short layout into the full layout and vice versa,
or
g) at least one alphabet of the alphanumeric keyboard virtually displayed,
or
h) a number of alphabets of the alphanumeric keyboard virtually displayed,
or
i) at least one layout of the keyboard virtually displayed into a lengthwise or a multi-directional or a horizontal or an upward or a diagonal layout,
or
j) layout of at least one alphabet on the alphanumeric keyboard virtually displayed into a lengthwise or a multi-directional or a horizontal or an upward layout or into the O/I display image layout or vice versa,
or
(k) any combination of mentioned in the sub-clauses (a)-(j);
herewith said electronic device is a mobile phone or a smart phone or a communicator or portable radio set or a game console or a digital camera or a digital camcorder.

13. The electronic device according to claim 12, wherein the electronic device is configured to disconnect the O/I display from the electronic device body, herewith being disconnected from the electronic device body, the O/I display interacts with said electronic device through a wired or a wireless connection or the O/I display stops interacting with the electronic device and it operates independently.

14. The electronic device according to claim 12, wherein there is at least one spatial position of the O/I display relative to the electronic device body, when the connection of the O/I display with the electronic device body is understood as a back-and-rigid connection.

15. The electronic device according to claim 12, wherein the body of an electronic device is a side slider or a double side slider or a multi-side slider or a side folder.

16. An electronic device, comprising:
a data output display, movable in one side relative to the electronic device body,
or
a data output and input display, movable in one side relative to the electronic device body (hereinafter “a data output display or a data output and input display” referred to as “O/I display”),
wherein:
under the O/I display is placed partially or entirely a touch screen display or a display of a non-sensor type or a partially touch screen display;
there is at least one position of the O/I display relative to the electronic device body, when the entire surface of a touch screen display or a display of a non-sensor type or a partially touch screen display is available for user manipulations;
herewith:
when the user releases from the hand or hands the electronic device
or
when the O/I display is moved or has been moved relative to the electronic device body
or
when the O/I display is fixed at least in one of spatial positions relative to the electronic device body:
on the O/I display,
or
on the O/I display and on said touch screen display or display of a non-sensor type or partially touch screen display are changed the following:
(a) the size or configuration or color or position at least of one displayed virtual symbol or virtual object or virtual icon,
or
(b) mutual position of the displayed virtual symbols or objects or icons,
or
(c) displayed virtual symbols or objects or icons into another symbols or objects or icons,
or
(d) the number of the displayed virtual symbols or objects or icons,
or
(e) horizontal layout of image into vertical layout of image and vice versa,
or
f) layout of the alphanumeric keyboard virtually displayed from short layout into the full layout and vice versa,
or
g) at least one alphabet of the alphanumeric keyboard virtually displayed,
or
h) a number of alphabets of the alphanumeric keyboard virtually displayed,
or
i) at least one layout of the keyboard virtually displayed into a lengthwise or a multi-directional or a horizontal or an upward or a diagonal layout,
or
j) layout of at least one alphabet on the alphanumeric keyboard virtually displayed into a lengthwise or a multi-directional or a horizontal or an upward layout or into the O/I display image layout or vice versa,
or
(k) any combination of mentioned in the sub-clauses (a)-(j);
herewith said electronic device is a mobile phone or a smart phone or a communicator or portable radio set or PDA or a game console or a digital camera or a digital camcorder or a netbook or an electronic book or a computer tablet or any other device with a Oil display, movable in one side relative to the electronic device body.

17. The electronic device according to claim 16, wherein the electronic device is configured to disconnect the O/I display from the electronic device body; herewith being disconnected from the electronic device body, the O/I display interacts with said electronic device through a wired or a wireless connection or the O/I display stops interacting with the electronic device and it operates independently.

18. The electronic device according to claim 16, wherein there is at least one spatial position of the O/I display relative to the electronic device body, when the connection of the O/I display with the electronic device body is understood as a back-and-rigid connection.

19. The electronic device according to claim 16, wherein the body of an electronic device is a side slider or a double side slider or a multi-side slider or a side folder.

20. An electronic device, comprising:
a data output display, movable in two lateral sides or more than in two sides relative to the electronic device body,
or
a data output and input display, movable in two lateral sides or more than in two sides relative to the electronic device body (hereinafter “a data output display or a data output and input display” referred to as “O/I display”),
wherein:
under the O/I display is placed partially or entirely a touch screen display or a display of a non-sensor type or a partially touch screen display;
there is at least one position of the O/I display relative to the electronic device body, when the entire surface of a touch screen display or a display of a non-sensor type or a partially touch screen display is available for user manipulations;
herewith:
when the electronic device takes at least one of spatial positions
or
when the user releases from the hand or hands the electronic device
or
when the O/I display is moved or has been moved relative to the electronic device body
or
when the O/I display is fixed at least in one of spatial positions relative to the electronic device body:
on the O/I display,
or
on said touch screen display or display of a non-sensor type or partially touch screen display,
or
on the Oil display and on said touch screen display or display of a non-sensor type or partially touch screen display, are changed the following:
(a) the size or configuration or color or position at least of one displayed virtual symbol or virtual object or virtual icon,
or
(b) mutual position of the displayed virtual symbols or objects or icons,
or
(c) displayed virtual symbols or objects or icons into another symbols or objects or icons,
or
(d) the number of the displayed virtual symbols or objects or icons,
or
(e) horizontal layout of image into vertical layout of image and vice versa,
or
f) layout of the alphanumeric keyboard virtually displayed from short layout into the full layout and vice versa,
or
g) at least one alphabet of the alphanumeric keyboard virtually displayed,
or
h) a number of alphabets of the alphanumeric keyboard virtually displayed,
or
i) at least one layout of the keyboard virtually displayed into a lengthwise or a multi-directional or a horizontal or an upward or a diagonal layout,
or
j) layout of at least one alphabet on the alphanumeric keyboard virtually displayed into a lengthwise or a multi-directional or a horizontal or an upward layout or into the On display image layout or vice versa,
or
(k) any combination of mentioned in the sub-clauses (a)-(j);
herewith said electronic device is a mobile phone or a smart phone or a communicator or portable radio set or PDA or a game console or a digital camera or a digital camcorder or a netbook or an electronic book or a computer tablet or any other device with a O/I display, movable in two lateral sides or more than in two sides relative to the electronic device body.

21. The electronic device according to claim 20, wherein the electronic device is configured to disconnect the O/I display from the electronic device body; herewith being disconnected from the electronic device body, the O/I display interacts with said electronic device through a wired or a wireless connection or the O/I display stops interacting with the electronic device and it operates independently.

22. The electronic device according to claim 20, wherein there is at least one spatial position of the O/I display relative to the electronic device body, when the connection of the O/I display with the electronic device body is understood as a back-and-rigid connection.

23. The electronic device according to claim 20, wherein the body of an electronic device is a side slider or a double side slider or a multi-side slider or a side folder.

24-27. (canceled)
